(19) United States
(12) Patent Application Publication
(10) Pub. No.: US 2005/0111077 A1
(43) Pub. Date: May 26, 2005

(54) Gain controller with selectable wavelength feedback

(76) Inventors: Ching-Wen Hsiao, Fengshan City (TW); Ting-Feng Wu, Kaohsiug Hsien (TW); Hung-Hsi Chen, Kaohsiung (TW)

Correspondence Address: DELLETT AND WALTERS, P. O. BOX 2786, PORTLAND, OR, 97208-2786, US

(21) Appl. No.: 10/720,363

(22) Filed: Nov. 24, 2003

(51) Int. Cl. H01S 3/00

(52) U.S. Cl. 359/337

(57) ABSTRACT

A gain controller has a tunable filter, a power detector and a filter controlling unit. The amplifier is connected in series in a major optical channel. The tunable filter is connected in parallel to the major optical channel to select a specific light signal from an output terminal of the amplifier and then output the specific light signal to the input terminal of the amplifier. The power detector and filter controlling unit is connected between an input terminal of the amplifier and the tunable filter to control the tunable filter output. The tunable filter outputs a light signal to the input terminal of the amplifier to maintain the input power of the amplifier. Therefore, gain of each light signal from the output terminal of the amplifier can be kept in a valuable range.

### BACKGROUND OF THE INVENTION

1. Field of the Invention

The present invention relates to a gain controller with selectable wavelength feedback, and more specifically to a gain controller that keeps the gain in each optic channel in a valuable range.

2. Description of Related Art

Wavelength division multiplexing (WDM) is one technique used in optic fiber networks. WDM provides multiple and different numbers of optical sub-channels for transmitting multiple light signals with different wavelengths on a single optical fiber. WDM systems have a large bandwidth and transmit large quantities of data. To transmit more data, a dense-WDM system has been developed.

The WDM system separates multiple light signals respectively into individual channels so an Erbium Doped Fiber Amplifier (EDFA) amplifier is required by the WDM system. The EDFA amplifier directly amplifies the light signals in an individual optical channel.

When the WDM system is setup, the number of optical channels can be selected. The number of optical channel is changed according to the requirements of different applications. However, the input power of an individual amplifier will increase when one light signal is dropped from the WDM system. Therefore, gain of each optical sub-channel of a WDM system varies when light signals are added or dropped. Consequently, the gain of each optical channel is not kept in a valuable range, so optical receivers connected to the corresponding optical sub-channels can be damaged or receive incorrect light signals.

To overcome the shortcomings, the present invention provides a gain controller with selectable wavelength feedback to mitigate or obviate the aforementioned problems.

### SUMMARY OF THE INVENTION

An objective of the present invention is to provide a gain controller with selectable wavelength feedback that keeps an input power of an amplifier in a valuable range so gain of each optical sub-channel is kept at a value in a range.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a gain controller in accordance with the present invention;

FIG. 2 is a block diagram of a second embodiment of a gain controller in accordance with the present invention; and

FIG. 3A is a total power curve for multiple light signals;

FIG. 3B is a power vs. wavelength curve for individual output signals corresponding to FIG. 3A; and

FIG. 3C is an output power curve at the second splitter in FIG. 1.

### DETAILED DESCRIPTION OF THE PREFERRED EMBODIMENT

A gain controller in accordance with the present invention keeps a gain of each sub-channel in a major optical channel of a wavelength division multiplexing (WDM) system in a valuable range. The major optical channel has multiple sub-channels for transmitting a number of light signals with different wavelengths. Basically, some of sub-channels are not used to transmit light data.

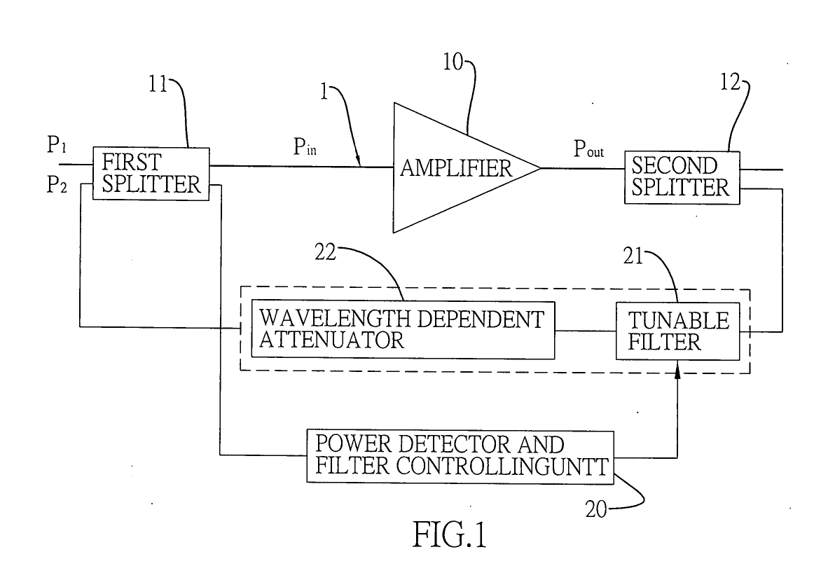

With reference to FIG. 1, a first embodiment of the gain controller in accordance with the present invention includes an amplifier (10), a first splitter (11), a second splitter (12), a tunable filter (21), a power detector and a filter adjusting unit (20) and a wavelength dependent attenuator (22).

The amplifier (10) has an input terminal (Pᵢₙ) and an output terminal (Pₒᵤₜ). The input terminal (Pᵢₙ) is connected to the first splitter (11) and the output terminal (pₒᵤₜ) is connected to the second splitter (12). The amplifier (10), the first splitter (11) and the second splitter (12) are connected in series to the major optical channel (1). Each splitter (11, 12) is an Erbium Doped Fiber Amplifier (EDFA) type and has inputs (not numbered) and outputs (not numbered). An input of the first splitter (11) and an output of the second splitter (12) are connected to the major optical channel (1). The first splitter (11) mixes signal lights and separates multiple power partials (not numbered). The second splitter (12) separates multiple power partials (not numbered). In this embodiment, the first splitter (11) separates power in the major optical channel (1) to a large partial (not numbered) and a small partial (not numbered). The large partial is input to the input terminal (Pᵢₙ) of the amplifier (10), and the small partial is input to the power detector and filter controlling unit (20). The second splitter (12) separates power in the major optical channel (1) to a large partial (not numbered) and a small partial (not numbered). The large partial is retained in the major optical channel (1), and the small partial is input to the tunable filter (21).

The tunable filter (21) has an input terminal (not numbered) and an output terminal (not numbered) and is connected to the output of the second splitter (12). Power from the output of the amplifier (10) is fed to the tunable filter (21) through the second splitter (12), and the tunable filter (21) allows a light signal with a specific wavelength to pass through the tunable filter (21).

The wavelength dependent attenuator (22) is connected to the output terminal of the tunable filter (21) and the input of the first splitter (11). The wavelength dependent attenuator (22) adjusts the power of the light signal with the specific wavelength from the tunable filter (21) and then outputs the light signal to the input of the first splitter (11). The first splitter (11) mixes the light signal into the major optical channel (1) to adjust input power of the amplifier (10). The light signal differs from the light signals transmitting data on the major optical channel (1) so the light signal added to the major optical channel does not effect the light signals with data.

The power detector and filter controlling unit (20) has an input port (not numbered) and a control port (not numbered). The input port is connected to one of the outputs of the first splitter (11) to obtain the small partial of the major optical channel (1). The power detector and filter controlling unit (20) senses power on the major optical channel (1) through the first splitter (11). The control port is connected to the tunable filter (21) and causes the tunable filter (21) to select one appropriate light signal with a specific wavelength to output.

The gain controller is a feedback amplifier with a feedback loop that is composed of the tunable filter (21) and the wavelength dependent attenuator (22). The power detector and filter controlling unit (20) detects power changes and then controls the tunable filter (21) to output a light signal with a specific wavelength. The wavelength dependent attenuator (22) adjusts the power of the light signal from the tunable filter (21) and then outputs the adjusted light signal to the input of the first splitter (11) to add to the major optical channel (1). Therefore, the input power of the amplifier is kept in a valuable range. That is, when the total power on the major optical channel (1) is kept in a valuable range, the gain of each sub-channel is approximately constant whether input light signals are added to or dropped from the major optical channel (1).

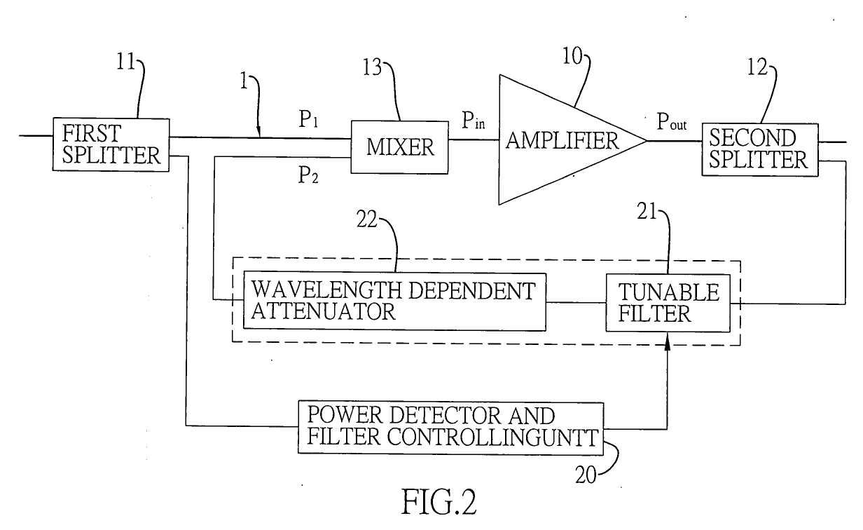

With reference to FIG. 2, a second embodiment of the gain controller in accordance with the present invention is the same as the second embodiment except a mixer (13) is added. The mixer (13) is connected between the output of first splitter (11) and the input terminal (Pᵢₙ) of the amplifier (10). The mixer (13) has inputs (P₁, P₂) and outputs (not numbered). One of the inputs (P₂) of the mixer (13) is connected to the wavelength dependent attenuator (22). The first splitter (11) is only connected to the power detector and filter controlling unit (20). Therefore, the power detector and filter controlling unit (20) senses the power in the major optical channel (1), which is not effected by the output signal of the wavelength dependent attenuator (22).

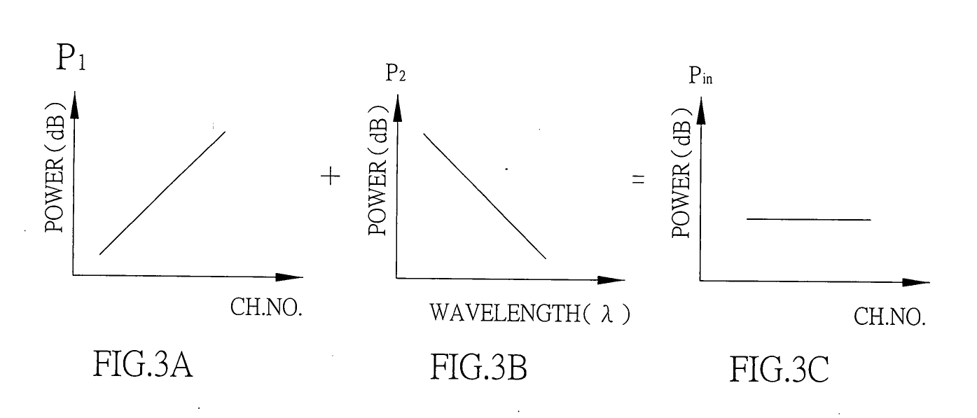

With reference to FIG. 3A, power in the major optical channel (1) rises as the number of sub-channels increases. With further reference to FIG. 3B, the wavelength dependent attenuator outputs a number of different light signals at different wavelengths based on changes in the number of sub-channels. The wavelength dependent attenuator outputs light signals with decreasing power so with reference to FIG. 3C, the input power of the amplifier is approximately constant. The input power of the amplifier can be kept in a valuable range by the gain controller so gain of each sub-channel is also kept in a valuable range without regard to the number of the input light signals are added to or dropped from the major optical channel. Therefore, the optical receiver will be damaged or receive incorrect signals from the major optical channel.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A gain controller, comprising:
an amplifier connected in series to a major optical channel of a wavelength division multiplexing (WDM) system, wherein the amplifier has an input terminal and an output terminal and the major optical channel has multiple sub-channels to transmit light signals with different wavelengths;
a power detector and filter controlling unit connected to the input terminal of the amplifier to detect power changes in the major optical channel;
a tunable filter having an input terminal connected the output terminal of the amplifier to output a specific light signal on one of the sub-channels by filtering wavelengths to the input terminal, wherein the tunable filter is connected to the power detector and filter controlling unit; and
a wavelength dependent attenuator connected between the input terminal of the amplifier and the tunable filter to adjust power of the specific light signal and then output the specific light signal to the input terminal of the amplifier;
whereby the power detector and filter controlling unit detects power changes of the major optical channel and then controls the tunable filter output specific light signals to the input terminal of the amplifier through the wavelength dependent attenuator to keep the power of the major optical channel in a valuable range.

2. The gain controller as claimed in claim 1, further comprising:
a first splitter connected in series to the major optical channel and having outputs and inputs, wherein the outputs are respectively connected to the input terminal of the amplifier and the power detector and filter controlling unit and one of the inputs is connected to the wavelength dependent attenuator; and
a second splitter connected in series to the major optical channel and having outputs and inputs, wherein one of the inputs of the second splitter is connected to the output terminal of the amplifier and one of outputs of the second splitter is connected to the tunable filter.

3. The gain controller as claimed in claim 1, further comprising:
a mixer connected in series to the major optical channel and having an output and inputs, wherein the output is connected to the input terminal of the amplifier and one input is connected to the wavelength dependent attenuator;
a first splitter connected to the major optical channel in serial and having an input and two outputs, wherein one input is connected to the input of the mixer and the other output is connected to the power detector and filter controlling unit; and
a second splitter connected to the major optical channel in serial and having outputs and inputs, wherein one of the inputs of the second splitter is connected to the output terminal of the amplifier and one of outputs of the second splitter is connected to the tunable filter.

4. The gain controller as claimed in claim 1, wherein the amplifier is an Erbium Doped Fiber Amplifier (EDFA) type.
